(19) United States
(12) Patent Application Publication
(10) Pub. No.: US 2026/0171287 A1
(43) Pub. Date: Jun. 18, 2026

(54) ELECTRONIC COMPONENT

(71) Applicant: Nihon Parkerizing Co., Ltd., Tokyo (JP)

(72) Inventors: Yuta Kobayashi, Tokyo (JP); Daisuke Wachi, Tokyo (JP); Sho Inomata, Tokyo (JP); Akino Nakatani, Tokyo (JP)

(21) Appl. No.: 18/853,751

(22) PCT Filed: Apr. 3, 2023
(86) PCT No.: PCT/JP2023/013782

§ 371 Date: Oct. 3, 2024

(30) Foreign Application Priority Data
Apr. 7, 2022 (JP) 2022-063744

(51) Int. Cl. H01B 7/29; H01B 3/40

(52) U.S. Cl. CPC H01B 7/29; H01B 3/40

(57) ABSTRACT

The present invention addresses the problem of providing an electronic component having excellent high-temperature durability. The problem is solved by an electronic component including a metal part and a film on the entirety or a portion of the metal part, in which the film comprises an amino group-modified epoxy resin or a salt thereof which is obtained by reacting a specific epoxy resin (A1) and a specific amine compound (A2).

### TECHNICAL FIELD

The present invention relates to an electronic component.

### BACKGROUND ART

In recent years, studies have been conducted on the formation of an excellent film on a metal material with the use of a surface treatment agent containing a specific resin. For example, Patent Document 1 discloses that a film having excellent corrosion resistance and the like can be formed by surface-treating a metal material with a cationic electrodeposition paint composition that contains an amino group-modified epoxy resin having a specific structure.

Meanwhile, the environments in which electronic components are used in various products have been increasingly diversified. Under this circumstance, electronic components are required to satisfy high durability in their use environments. Patent Document 2 discloses that an electronic component excellent in moisture resistance, chemical resistance, and the like can be obtained by, in an electronic component that includes an insulator containing a metal magnetic powder, forming a resin coating film on the insulator.

### RELATED ART DOCUMENTS

### Patent Documents

[Patent Document 1] WO 2017/038631
[Patent Document 2] WO 2016/013643

### SUMMARY OF THE INVENTION

### Problems to be Solved by the Invention

As described above, electronic components are required to satisfy high durability in their use environments. For example, electronic components used in automobiles and the like are required to maintain their performance, such as insulating properties, over an extended period even in a high-temperature environment (high-temperature durability). The electronic component disclosed in Patent Document 2, on which a coating film is formed, has room for improvement in terms of the high-temperature durability. An object of the present invention is to provide an electronic component that is excellent in the high-temperature durability.

### Means for Solving the Problems

The present invention encompasses, for example, the following.

[1] An electronic component, including:
a metal part; and
a film on the entirety or a portion of the metal part,
wherein
the film contains an amino group-modified epoxy resin or a salt thereof which is obtained by reacting an epoxy resin (A1) and an amine compound (A2), and
the epoxy resin (A1) is obtained by reacting a propylene oxide-added diepoxy resin (a1) represented by Formula (1), a bisphenol compound (a2), a diepoxy resin (a3) different from Formula (1), and a dicarboxylic acid (a4) in which two carboxyl groups are bound via at least one carbon atom:

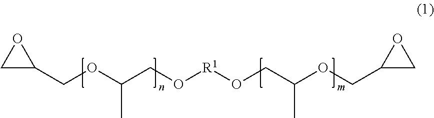

[wherein, R¹ represents an alkylene group having 3 to 10 carbon atoms which optionally has a substituent, a cyclohexylene group which optionally has a substituent, a phenylene group which optionally has a substituent, or —R^{a}—R^{b}—R^{c}—; R^{a} and R^{c} each represent a cyclohexylene group or a phenylene group; R^{b} represents a methylene group which optionally has one or two substituents; and m and n each independently represent an integer of 1 to 20].

[2] The electronic component according to [1], which is selected from the group consisting of an electronic component, a bus bar, a reactor, an electric wire, and a sintered magnet, which constitute a motor.

[3] An electronic component, including:
a metal part; and
a film on the entirety or a portion of the metal part,
wherein
the film contains an amino group-modified epoxy resin or a salt thereof, and the resin contains a structural unit derived from an epoxy resin (A1) and a structural unit derived from an amine compound (A2), and
the epoxy resin (A1) contains a structural unit derived from a propylene oxide-added diepoxy resin (a1) represented by Formula (1), a structural unit derived from a bisphenol compound (a2), a structural unit derived from a diepoxy resin (a3) different from Formula (1), and a structural unit derived from a dicarboxylic acid (a4) in which two carboxyl groups are bound via at least one carbon atom:

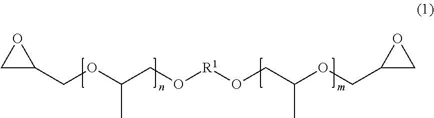

[wherein, R¹ represents an alkylene group having 3 to 10 carbon atoms which optionally has a substituent, a cyclohexylene group which optionally has a substituent, a phenylene group which optionally has a substituent, or —R^{a}—R^{b}—R^{c}—; R^{a} and R^{c} each represent a cyclohexylene group or a phenylene group; R^{b} represents a methylene group which optionally has one or two substituents; and m and n each independently represent an integer of 1 to 20].

### Effects of the Invention

According to the present invention, an electronic component that includes a film having excellent high-temperature durability can be obtained.

### MODE FOR CARRYING OUT THE INVENTION

The electronic component according to one embodiment of the present invention, which includes a film on the entirety or a portion of a metal part, and a method of producing the same will now be described.

### <Electronic Component>

An electronic component that can be used in the present embodiment is not particularly limited as long as it includes a metal part and the entirety or a portion of the surface is composed of a metal. Examples of the type of the electronic component include electronic components (e.g., stators, rotors, and lead wires), bus bars, reactors, electric wires, and sintered magnets, which constitute motors.

Examples of the metal constituting the entirety or a portion of the surface of the electronic component include, but are not particularly limited to, iron, iron alloys, aluminum, aluminum alloys, copper, and copper alloys. The metal may be configured to be in the form of a film on the entirety or a portion of the surface of the electronic component. Specific examples of the film of the metal include those films formed by a sputtering method, a CVD method, a laser deposition method, an ink-jet method, a pattern plating transfer method, a damascene method, or the like on the surfaces of materials, such as various metal materials (including alloy materials); ceramics; glasses; resin films; and wafers of silicon, silicon carbide (SiC), sapphire, glass, gallium phosphide (GaP), gallium arsenide (GaAs), indium phosphide (InP), gallium nitride (GaN), and the like. Other film (e.g., a film of titanium or a titanium alloy) may also be formed between any of the above-described materials and the film of the metal by a vapor deposition method, a sputtering method, or the like. The titanium alloy is not particularly limited as long as it contains titanium and a metal element other than titanium, with titanium being contained in the largest amount. Specific examples of the titanium alloy include titanium-palladium alloys, titanium-nickel-chromium-ruthenium-palladium alloys, titanium-tantalum alloys, titanium-palladium-cobalt alloys, titanium-nickel-ruthenium alloys, titanium-aluminum alloys, and titanium-aluminum-vanadium alloys, which are prescribed in JIS H4600:2012.

A size of the metal part of the electronic component is not particularly limited and varies depending on the type of the electronic component, and the electronic component is not a large component such as an automobile body.

The size of the electronic component may be, for example, 1 mm or more, 10 mm or more, but 1,000 mm or less, 500 mm or less, or 300 mm or less, in terms of the major axis.

Specific examples of the above-described electronic component include the following.

WO 2019/077793 discloses a stator coil which includes an insulating cover material (6) composed of: a mica layer (7) containing mica; and a reinforcing layer (8) that is laminated on the mica layer (7) and contains filler particles (10) and a reinforcing material (11). The film according to the present embodiment can be applied to this stator coil.

Japanese Unexamined Patent Application Publication No. 2019-116552 discloses an insulating sheet 1 which fills a gap between a stator core 12 and a stator coil 11 and thereby insulates and adheres these members. The film according to the present embodiment can be applied to fill the gap between the stator core 12 and the stator coil 11.

In Japanese Unexamined Patent Application Publication No. 2020-114179, with regard to a collar 13 and a coil end 12a which are provided in a stator 10 of a rotary electric machine, it is described that an elastic object (e.g., an insulating paper) can be arranged between an outer periphery 13c of the collar 13 and an inner periphery 12b of the coil end 12a. The film according to the present embodiment can be applied as the elastic object.

In Japanese Unexamined Patent Application Publication No. 2019-6924, with regard to a stator 20 which includes a stator core 21, a large number of slots 15 arranged on an inner peripheral part of the stator core 21, and a stator coil 60 wound on the slots 15, it is described to cover the stator coil 60 with a cured product of a resin composition for electric equipment insulation. Further, in Japanese Unexamined Patent Application Publication No. 2016-124878, it is described to cover the stator coil 60 with a resin composition 601. The film according to the present embodiment can be applied to the stator coil 60.

Japanese Unexamined Patent Application Publication No. 2015-171249 describes that insulation coating is performed on a stator core 11 used in a stepping motor 10. The film according to the present embodiment can be applied to the stator core 11.

Japanese Unexamined Patent Application Publication No. 2021-60263 discloses a double redundant system resolver in which only one annular stator (10) having a large number of protruding magnetic poles (13) is used. It is described that, in this double redundant system resolver, gaps between divided cores (21), each of which is formed of a pair of the protruding magnetic poles (13) as a single component, are insulated by a non-magnetic material (20). The film according to the present embodiment can be applied as the non-magnetic material (20) between the divided cores (21).

In Japanese Unexamined Patent Application Publication No. 2020-18080, it is described that, on the entire surfaces of an annular stator 1 and magnetic poles 2, an annular insulating cap 4 used for obtaining insulation between these members and a stator winding 10 wound on each magnetic pole 2 is formed. The film according to the present embodiment can be applied as the annular insulating cap 4.

In Japanese Unexamined Patent Application Publication No. 2020-145854, it is described that, in a stator which includes a motor core having plural core parts arranged in an annular shape and air-core coils inserted into the core parts, an insulating paper is arranged between the respective core parts and air-core coils. The film according to the present embodiment can be applied in place of the insulating paper.

WO 2021/153540 discloses a motor stator 30 which is formed by superposing electromagnetic steel sheets and includes a stator core 31, an insulator 34, and an excitation coil 35. The film according to the present embodiment can be applied as the insulator 34.

The motor disclosed in Japanese Unexamined Patent Application Publication No. 2021-118674 is described to, as a desired aspect, include an insulating material that insulates a stator core and a motor winding. The film according to the present embodiment can be applied as the insulating material.

In Japanese Unexamined Patent Application Publication No. 2020-102898, it is described that a coil part 20 constituting a stator 100 is formed by bonding plural rectangular conductive wires 20a with one another, and that the rectangular conductive wires 20a are each formed such that the periphery of a conductive member 20b is covered with an insulating film 20c. The film according to the present embodiment can be applied as the insulating film 20c.

In Japanese Unexamined Patent Application Publication No. 2021-52462, it is described that a resin film 14 is formed on the outer circumferential surface of a cylindrical covering member 13 of a rotor 10. The film according to the present embodiment can be applied as the resin film 14.

In Japanese Unexamined Patent Application Publication No. 2019-176616, it is described that a stationary part 3 of a motor MT includes a plate-like wiring member 36 and a conductive member (lead wire) 306 through which an electric current flows, and that the lead wire has a cover formed of an insulator. The film according to the present embodiment can be applied as the cover formed of an insulator.

Japanese Unexamined Patent Application Publication No. 2021-89890 discloses an inter-terminal connection structure in which terminal portions of plural devices are connected to each other in an electrically conductive state via a conductive member arranged between the terminal portions. The film according to the present embodiment can be applied to a bus bar 56, a bolt 84, and the like that are used in a conductive component 54 of the inter-terminal connection structure.

Japanese Unexamined Patent Application Publication No. 2021-48001 discloses a bus bar having an insulating layer (insulated bus bar 10) that is used as a wiring member for transmission of electric current in a power conversion device such as an inverter or a converter. The film according to the present embodiment can be applied as an insulating layer 2 of the insulated bus bar.

Japanese Unexamined Patent Application Publication No. 2021-57139 discloses a bus bar assembly including first and second bus bars which are arranged in the same plane with a gap existing therebetween, and are connected in an insulated state by an insulating resin layer that includes a gap filling part filled into the gap. It is described that INSULEED (registered trademark) is preferably utilized as an insulating resin material that forms an insulating resin layer 30 of the bus bar assembly. The film according to the present embodiment can be applied as the insulating resin material.

Japanese Unexamined Patent Application Publication No. 2019-153501 discloses an insulated flat rectangular conductor which includes a flat rectangular conductor and an insulating film covering the flat rectangular conductor, and also discloses a coil in which the insulated flat rectangular conductor is used. The film according to the present embodiment can be applied as the insulating film.

In Japanese Unexamined Patent Application Publication No. 2019-197779, it is described that a conductive wire 10 of a coil 1 constituting a reactor is covered with an insulating material. The film according to the present embodiment can be applied as a cover formed of the insulating material.

Japanese Unexamined Patent Application Publication No. 2019-87540 discloses an insulated electric wire for railway vehicles. The insulated electric wire is configured such that plural layers are arranged on the outer periphery of a conductor 110. The film according to the present embodiment can be applied as, among the plural layers, a semi-conductive layer 130 that is in contact with the conductor 110.

Japanese Unexamined Patent Application Publication No. 2019-117793 discloses an insulated electric wire and a cable that are used for internal wiring of electronic devices. This insulated electric wire is composed of a conductor and an insulating layer that is coated on the outer periphery of the conductor and formed of a vinyl chloride composition, and the film according to the present embodiment can be applied as the insulating layer.

Japanese Unexamined Patent Application Publication No. 2019-106387 discloses a multilayer insulated electric wire and a multilayer insulated cable that are applied to railway vehicles, automobiles, instruments, and the like. A two-layer insulated electric wire 10, which is one embodiment of the multilayer insulated electric wire, includes a conductor 11, an insulating inner layer 12 coated on the conductor 11, and an insulating outer layer 13 coated on the insulating inner layer 12, and the film according to the present embodiment can be applied as the insulating inner layer 12.

Japanese Unexamined Patent Application Publication No. 2021-111448 discloses an enamel wire used in motors, such as industrial motors. This enamel wire is composed of a conductor and an insulating film, and the film according to the present embodiment can be applied as the insulating film.

Japanese Unexamined Patent Application Publication No. 2021-141011 discloses an electric coil used in various electric instruments, such as motors and transformers. An insulated copper wire is wound on the electric coil, and this insulated copper wire includes a copper wire and an insulating film covering the surface of the copper wire. The film according to the present embodiment can be applied as the insulating film covering the surface of the copper wire.

Japanese Unexamined Patent Application Publication No. 2020-161410 discloses an insulated electric wire used in coils and the like of vehicle motors. The insulated electric wire includes a conductive part 1 having plural element wires 11, and an insulating layer 2 covering the outer periphery of the conductive part 1. The film according to the present embodiment can be applied as the insulating layer 2.

Japanese Unexamined Patent Application Publication No. 2021-153109 discloses a sintered magnet used in products, such as motors for household electric appliances and industrial use, driving motors of electric vehicles (EVs) and hybrid electric vehicles (HEVs), and motors for electric power steering (EPS). It is described that the sintered magnet may be subjected to a surface treatment with a resin paint, and the film according to the present embodiment can be applied as the surface treatment.

### <Film>

The electronic component according to the present embodiment includes a metal part, and a film on the entirety or a portion of the metal part. The film contains an amino group-modified epoxy resin (hereinafter, referred to as “resin”) or a salt thereof. The film allows the electronic component according to the present embodiment to have improved high-temperature durability and an extended life, as a result of which effective utilization of resources can be achieved.

### <Resin or Salt Thereof>

The resin according to the present embodiment will now be described. In the following, there are descriptions of groups containing a hydrocarbon moiety, such as “alkyl” “alkylene” “alkenyl” “alkadienyl” “hydroxyalkyl” “alkylene glycol” and “alkanolamine”. In these descriptions, unless otherwise specified, the groups preferably each independently have 1 to 6 carbon atoms. Further, each raw material may be used singly, or in combination of two or more kinds thereof.

In the present embodiment, the resin contained in the film contains a structural unit derived from an epoxy resin (A1) and a structural unit derived from an amine compound (A2). The epoxy resin (A1) contains a structural unit derived from a propylene oxide-added diepoxy resin (a1) represented by Formula (1), a structural unit derived from a bisphenol compound (a2), a structural unit derived from a diepoxy resin (a3) different from Formula (1), and a structural unit derived from a dicarboxylic acid (a4) in which two carboxyl groups are bound via at least one carbon atom. The epoxy resin (A1) is hereinafter also referred to as “amino group-modified epoxy resin”.

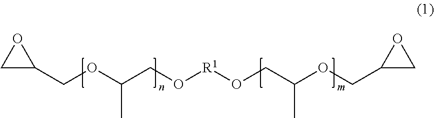

[wherein, R¹ represents an alkylene group having 3 to 10 carbon atoms which optionally has a substituent, a cyclohexylene group which optionally has a substituent, a phenylene group which optionally has a substituent, or —R^{a}—R^{b}—R^{c}—; R^{a} and R^{c} each represent a cyclohexylene group or a phenylene group; R^{b} represents a methylene group which optionally has one or two substituents; and m and n each independently represent an integer of 1 to 20].

The resin is obtained by reacting the epoxy resin (A1) and the amine compound (A2). Further, the epoxy resin (A1) is obtained by reacting the propylene oxide-added diepoxy resin (a1), the bisphenol compound (a2), the diepoxy resin (a3) different from (a1), and the dicarboxylic acid (a4) in which two carboxyl groups are bound via at least one carbon atom. These raw materials will now each be described in detail.

The propylene oxide-added diepoxy resin (a1) is a resin represented by Formula (1). In Formula (1), R¹ represents an alkylene group having 3 to 10 carbon atoms which optionally has a substituent, a cyclohexylene group which optionally has a substituent, a phenylene group which optionally has a substituent, or —R^{a}—R^{b}—R^{c}—; R^{a} and R^{c} each represent a cyclohexylene group or a phenylene group; R^{b} represents a methylene group which optionally has one or two substituents; and m and n each independently represent an integer of 1 to 20.

Examples of substituents in the alkylene group having 3 to 10 carbon, the cyclohexylene group, the phenylene group, and the methylene group, which groups have a substituent, include alkyl groups and phenyl group. These substituents may be further substituted with other functional groups (e.g., alkyl groups and phenyl group). The alkyl groups may be in any of a linear form, a branched form, and a cyclic form. Unless otherwise specified, the term “substituent” used herein means any of such alkyl groups, phenyl group, and the like.

In Formula (1), R¹ is, for example, a bis-cyclohexylene group represented by the following Formula (3), a bis-phenylene group represented by the following Formula (4), or a phenylene group represented by the following Formula (5). In Formula (3), X² and Y² each independently represent a hydrogen atom, an alkyl group, or a phenyl group. In Formula (4), X³ and Y³ each independently represent a hydrogen atom, an alkyl group, or a phenyl group. In Formula (5), X⁴ and Y⁴ each independently represent a hydrogen atom, an alkyl group, a phenyl group, an alkoxyl group, or a hydroxyl group. The alkyl groups represented by X², Y², X³, Y³, X⁴ and Y⁴ are not particularly limited as long as they are in a linear or branched form; however, the alkyl groups are each preferably an alkyl group having 1 to 6 carbon atoms, more preferably an alkyl group having 1 to 3 carbon atoms. Further, the alkoxyl groups represented by X⁴ and Y⁴ are not particularly limited as long as they are in a linear or branched form; however, the alkoxyl groups are each preferably an alkoxyl group having 1 to 6 carbon atoms, more preferably an alkoxyl group having 1 to 3 carbon atoms.

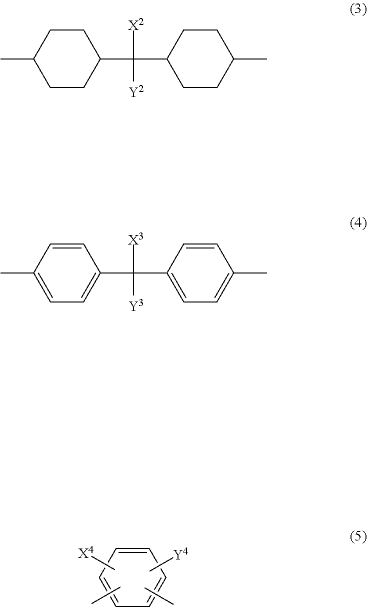

In Formula (1), m and n may each be an integer of 1 to 20 as described above; however, m and n are each preferably an integer of 1 to 5, and m and n are both more preferably an integer of 1 to 3, particularly preferably 1.

The propylene oxide-added diepoxy resin (a1) of Formula (1) can be obtained by any known method, more specifically, by adding or addition-polymerizing propylene oxide to a polyol compound having a hydroxyl group on both ends of R¹, and diepoxidizing the resulting polyether compound (having a hydroxyl group on both ends) through a reaction with epichlorohydrin.

More specific examples of the polyol compound include: linear or cyclic alkylene glycols in which hydroxy groups are bound to the carbon atoms of both ends, such as 1,3-propanediol, 1,4-butanediol, 1,5-pentanediol, 1,6-hexanediol, 1,7-heptanediol, 1,8-octanediol, 1,9-nonanediol, 1,10-decanediol, and 1,4-cyclohexanediol; polyhydric phenols having two or more hydroxy groups, such as catechol, resorcinol, hydroquinone, and pyrogallol; and polyphenol compounds and hydrogenated products thereof, such as 2,2-bis(4-hydroxycyclohexyl)propane (hydrogenated bisphenol A), hydrogenated bisphenol F, hydrogenated bisphenol E, hydrogenated bisphenol B, hydrogenated bisphenol AP, hydrogenated bisphenol BP, bisphenol A, bisphenol F, bisphenol E, bisphenol B, bisphenol AP, and bisphenol BP.

The bisphenol compound (a2) is not particularly limited as long as it is a compound having two phenolic OH groups in one molecule, and examples thereof include bisphenol A, bisphenol F, bisphenol E, bisphenol B, bisphenol S, bisphenol AP, and bisphenol BP. Thereamong, bisphenol A and bisphenol F are preferred.

The diepoxy resin (a3) is a compound having two epoxy groups in one molecule, which is different from the above-described propylene oxide-added diepoxy resin (a1). The diepoxy resin (a3) has an epoxy equivalent in a range of generally 170 to 500, preferably 170 to 400. The diepoxy resin (a3) is preferably a compound represented by the above-described Formula (2). In Formula (2), R³ and R⁴ may be the same or different, and examples thereof include a single bond, an alkylene group, a phenylene group, and a cyclohexylene group. X¹ and Y¹ each independently represent a hydrogen atom or an alkyl group. The alkyl groups represented by X¹ and Y¹ are not particularly limited as long as they are in a linear or branched form; however, the alkyl groups are each preferably an alkyl group having 1 to 6 carbon atoms, more preferably an alkyl group having 1 to 3 carbon atoms.

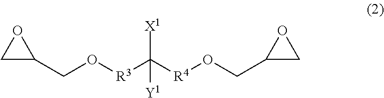

The diepoxy resin (a3) can be obtained by, for example, a reaction between the above-described polyol compound or an alkylene glycol having two or more carbon atoms in which two hydroxy groups; one hydroxy group and one hydroxyalkyl group, phenol group, or cyclohexanol group; one hydroxyalkyl group and one phenol group or cyclohexanol group; one phenol group and one cyclohexanol group; or two hydroxyalkyl groups (which may be the same or different) are bound to the same carbon atom, and an epihalohydrin (e.g., epichlorohydrin). Examples of the alkylene glycol include: alkylene glycols in which two hydroxy groups are bound to the same carbon atom, such as 1,1-dihydroxyethane, 1,1-dihydroxypropane, and 2,2-dihydroxypropane; alkylene glycols in which one hydroxy group and one hydroxyalkyl group are bound to the same carbon atom, such as 2-hydroxypropanol and 2-hydroxybutanol; alkylene glycols in which one or two kinds of hydroxyalkyl groups are bound to the same carbon atom, such as 2,2-(dihydroxymethyl)ethane, 2,2-(dihydroxyethyl)propane, 2,2-dimethyl-1,3-propanediol, 2,2-dimethyl-1,4-butanediol, and 3,3-diethyl-1,6-hexanediol; alkylene glycols in which one hydroxy group and one phenol group are bound to the same carbon atom, such as 4-(1-hydroxyethyl)phenol, 3-(1-hydroxyethyl)phenol, and 4-(1-hydroxypropyl)phenol; alkylene glycols in which one hydroxy group and one cyclohexanol group are bound to the same carbon atom, such as 4-(1-hydroxyethyl)cyclohexanol and 2-(1-hydroxyethyl)cyclohexanol; alkylene glycols in which one hydroxyalkyl group and one phenol group are bound to the same carbon atom, such as 4-hydroxyphenyl-2-propanol and 4-hydroxyphenyl-2-butanol; alkylene glycols in which one hydroxyalkyl group and one cyclohexanol group are bound to the same carbon atom, such as 2-(4-hydroxycyclohexyl)-1-propanol and 2,2-dimethyl-2-(4-hydroxycyclohexyl)-1-ethanol; and alkylene glycols in which one phenol group and cyclohexanol group are bound to the same carbon atom, such as 2-(4-hydroxyphenyl)-2-(4-hydroxycyclohexyl)propane and 1-(4-hydroxyphenyl)-1-(4-hydroxycyclohexyl)propane.

In the production of the diepoxy resin (a3), in addition to the above-described polyol compound and various alkylene glycols, for example, 4,4′-dihydroxybenzophenone, bis(4-hydroxyphenyl)-1,1-isobutane, bis(4-hydroxy-2-tert-butylphenyl)-2,2-propane, bis(4-hydroxy-3-tert-butylphenyl)-2,2-propane, bis(2-hydroxynaphthyl)methane, tetrakis(4-hydroxyphenyl)-1,1,2,2-ethane, 4,4′-dihydroxydiphenylsulfone, 2,2-bis(4-hydroxyphenyl)hexafluoropropane, bis(4-hydroxyphenyl)-2,2-dichloroethylene, or 2,2-bis(3-methyl-4-hydroxyphenyl)propane can be used.

In the production of the resin, the diepoxy resin (a3) obtained from these raw materials may be used singly, or in combination of two or more kinds thereof. In the case of producing the resin using two or more kinds of diepoxy resins (a3), the diepoxy resins (a3) may be added separately or simultaneously.

The dicarboxylic acid (a4) is a compound in which two carboxyl groups are bound via at least one carbon atom. A preferred dicarboxylic acid is a compound in which two carboxyl groups are bound via a linear alkylene group (R²) having 1 to 20 carbon atoms as shown in the following Formula (6). In the compound of Formula (6), the alkylene group (R²) may have one or more substituents of a single kind that are selected from alkyl groups, alkenyl groups, alkadienyl groups, and a methylene group, or may have one or more substituents of each of two or more kinds that are selected from alkyl groups, alkenyl groups, alkadienyl groups, and a methylene group. When the alkylene group (R²) in the compound of Formula (6) has 2 to 20 carbon atoms, a ring may be formed via adjacent carbon atoms of the alkylene group. The ring may have one or more substituents selected from alkyl groups and alkenyl groups, preferably two substituents that are an alkyl group(s) and/or an alkenyl group(s). When the ring has two substituents, the two substituents may be the same or different. Examples of the ring include a cyclohexane ring, a cyclohexene ring, a benzene ring, and a bicyclo ring (e.g., bicyclo[4.4.0]decane-1,7-diene) in which two carbon-carbon bonds of a decalin ring are double bonds. The alkyl groups, the alkenyl groups, and the alkadienyl groups that are optionally contained in the alkylene group (R²), as well as the alkyl groups and the alkenyl groups that are optionally contained in the ring may each be in a linear or branched form.

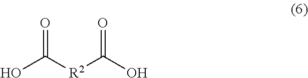

A more preferred dicarboxylic acid (a4) is a compound that is cyclic and/or has an unsaturated bond. A particularly preferred dicarboxylic acid (a4) is, among compounds of Formula (6), one in which: the number of carbon atoms of the alkylene group (R²) is 2 to 18; and the alkylene group (R²) optionally has one methylene group, one or two alkyl groups having 5 to 9 carbon atoms, or two substituents of one or two kinds that are selected from alkyl, alkenyl, and alkadienyl groups having 5 to 9 carbon atoms, or any of the above-described rings is formed via adjacent carbon atoms of the alkylene group (R²) and the ring optionally has two substituents that are each independently an alkyl, alkenyl, or alkadienyl group having 5 to 9 carbon atoms.

Examples of the dicarboxylic acid (a4) include malonic acid, succinic acid, glutaric acid, 2,2-dimethylglutaric acid, 3,3-dimethylglutaric acid, adipic acid, 2,2-dimethyladipic acid, pimelic acid, suberic acid, azelaic acid, 2-ethylazelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetradecanedicarboxylic acid, 1,15-pentadecanedicarboxylic acid, 1,16-hexadecanedicarboxylic acid, 1,17-heptadecanedicarboxylic acid, 1,18-octadecanedicarboxylic acid, 1,19-nonadecanedicarboxylic acid, 1,20-icosanedicarboxylic acid, itaconic acid, phthalic acid, dimer acids, 1,2-cyclohexanedicarboxylic acid, and 1,2-cyclohexenedicarboxylic acid.

Examples of a dimer acid that can be used as a raw material of the epoxy resin (A1) in the present embodiment include commercially available dimer acids, such as HARIDIMER 200, 250, and 2705 (which are manufactured by Harima Chemicals Group, Inc.); TSUNODIME 205, 216, 228, 395, and 346 (which are manufactured by Tsuno Co., Ltd.); UNYDYME 14, 14R, T-17, 18, T-18, 22, T-22, 27, 35, M-9, M-15, M-35, and 40, CENTURY D-75, D-77, D-78, and D-1156, as well as SYLVATAL 7001 and 7002 (which are manufactured by Arizona Chemical Holdings Corporation); EMPOL 1016, 1003, 1026, 1028, 1061, 1062, 1008, and 1012 (which are manufactured by BASF Japan Ltd.); and hydrogenated dimer acids (average Mₙ=˜570; manufactured by Sigma-Aldrich Co., LLC).

The amine compound (A2) used in the present embodiment is a raw material for introducing an amino group into the epoxy resin (A1). Therefore, the amine compound (A2) contains at least one active hydrogen that can react with an epoxy group. The amine compound (A2) is not particularly limited as long as it is capable of introducing an amino group, and examples thereof include monomethylamine, dimethylamine, monoethylamine, diethylamine, monoisopropylamine, diisopropylamine, monobutylamine, dibutylamine, monoethanolamine, diethanolamine, mono(2-hydroxypropyl)amine, di(2-hydroxypropyl)amine, monomethylaminoethanol, monoethylaminoethanol, ethylene diamine, propylene diamine, butylene diamine, hexamethylene diamine, tetraethylene pentamine, pentaethylene hexamine, diethylaminopropylamine, and diethylene triamine, among which alkanolamines are preferred. As for primary amines, those that have been ketiminated can be used as well. These amine compounds may be used singly, or in combination of two or more kinds thereof. In the case of producing the resin using two or more kinds of amine compounds (A2), the amine compounds (A2) may be added separately or simultaneously.

### <Method of Producing Resin or Salt Thereof>

### <Method of Producing Epoxy Resin (A1)>

Next, a method of producing the epoxy resin (A1) will be described in detail. The epoxy resin (A1) can be produced by, for example, allowing a mixture, which is obtained by blending raw materials of the propylene oxide-added diepoxy resin (a1), the bisphenol compound (a2), the diepoxy resin (a3), and the dicarboxylic acid (a4), to react at a prescribed temperature with stirring. In order to accelerate the reaction, it is preferred to further add a reaction catalyst to the mixture.

The reaction catalyst is not particularly limited as long as it can accelerate the reaction and, for example, any of the following can be used: tertiary amines, such as dimethylbenzylamine, triethylamine, and tributylamine; and quaternary ammonium salts, such as tetraethylammonium bromide and tetrabutylammonium bromide. It is desired to control the synthesis temperature to be 70° C. to 200° C., taking into consideration the progress of the reaction.

The epoxy resin obtained by the above-described production method has an epoxy equivalent of, for example, desirably 1,000 to 5,000, more desirably 1,250 to 4,000, particularly desirably 1,500 to 3,000. The epoxy resin (A1) having an epoxy equivalent in this range enables the production of a resin useful as a raw material of a cationic electrodeposition paint composition that can not only realize superior liquid stability but also efficiently form a film having a prescribed thickness. The epoxy equivalent can be measured in accordance with the potentiometric titration method of JIS K7236. For the measurement, a commercially available potentiometric titrator (e.g., AT-610 manufactured by Kyoto Electronics Manufacturing Co., Ltd.) can be used.

In the production of the epoxy resin (A1), the blending ratios of the propylene oxide-added diepoxy resin (a1), the bisphenol compound (a2), the diepoxy resin (a3), and the dicarboxylic acid (a4) are as follows with respect to a total mass of these raw materials (a1) to (a4). The blending ratio of the propylene oxide-added diepoxy resin (a1) is desirably 1 to 50% by mass, more desirably 5 to 45% by mass, most desirably 10 to 40% by mass. The blending ratio of the dicarboxylic acid (a4) is desirably 1 to 20% by mass, more desirably 5 to 20% by mass, most desirably 10 to 20% by mass. The blending ratio of the remainder is that of the bisphenol compound (a2) and the diepoxy resin (a3), which is desirably 1% by mass or more.

The above-described reaction may be performed in a solvent by adding the raw materials to the solvent as appropriate. The solvent is not particularly limited as long as it is usually used in the production of a resin, and examples thereof include: hydrocarbon-based solvents, such as toluene, xylene, and hexane; ester-based solvents, such as methyl acetate and ethyl acetate; ketone-based solvents, such as acetone, methyl ethyl ketone, and methyl isobutyl ketone; amide-based solvents, such as dimethylformamide and dimethylacetamide; alcohol-based solvents, such as methanol, ethanol, and isopropanol; and ether alcohol-based solvents, such as ethylene glycol monobutyl ether and ethylene glycol monohexyl ether. These solvents may be used singly, or in combination of two or more kinds thereof as a mixture.

### <Method of Producing Resin>

Next, a method of producing a resin will be described in detail. As described above, a resin can be obtained by reacting the epoxy resin (A1) and the amine compound (A2). The reaction temperature and the reaction time are preferably, for example, 70° C. to 110° C. and 1 to 5 hours, respectively. In the production of a resin, the blending amount of the amine compound (A2) is preferably adjusted such that the resulting resin has an amine value in a range of 5 mgKOH/g to 30 mgKOH/g. Accordingly, the amine value of the resulting resin is preferably in a range of 5 mgKOH/g to 30 mgKOH/g, more preferably in a range of 5 mgKOH/g to 20 mgKOH/g, particularly preferably in a range of 10 mgKOH/g to 20 mgKOH/g. The amine value, i.e. the total amine value of the resin, can be measured in accordance with the potentiometric titration method of JIS K7237.

In a case where unreacted epoxy groups exist even with the adjustment of the amine value, a compound capable of reacting with epoxy groups may be reacted with the unreacted epoxy groups. Examples of the compound reacted with the unreacted epoxy groups include, but are not particularly limited to, phenol compounds, carboxylic acids, xylene-formaldehyde resins, and ε-caprolactone.

In the reaction of the epoxy resin (A1) and the amine compound (A2), the same solvent as the above-described solvent used for the production of the epoxy resin (A1) can be used; however, the solvent is not limited thereto, and other solvent may be used as well.

By neutralizing amino groups contained in the structure of the resin with a neutralizing acid, the resin can be used in the form of a salt. The neutralizing acid is not particularly limited as long as it is capable of cationizing the amino groups contained in the resin and, for example, an organic carboxylic acid such as formic acid, acetic acid, lactic acid, sulfamic acid, or methanesulfonic acid can be used. Particularly, a strong acid with which a more stable low-amine-value resin emulsion can be produced, such as methanesulfonic acid, is desirably used. These acids may be used singly, or in combination of two or more kinds thereof. In the case of using two or more kinds of acids, the acids may be added separately or simultaneously. The amino groups are cationized for the purpose of imparting the resin with water dispersibility. The cationization may be performed for all of the amino groups, or may be performed for some of the amino groups.

The resin or salt thereof contained in the film according to the present embodiment may be in its original form, or in the form of a cross-linked product. The resin or salt thereof may also be in a form of being cross-linked with a curing agent such as a polyisocyanate compound.

Examples of the polyisocyanate compound include tolylene diisocyanate, xylylene diisocyanate, phenylene diisocyanate, diphenylmethane-2,4′-diisocyanate, diphenylmethane-4,4′-diisocyanate, polymeric MDI (crude MDI: polymethylene polyphenyl polyisocyanate), bis(isocyanate methyl)cyclohexane, tetramethylene diisocyanate, hexamethylene diisocyanate, methylene diisocyanate, and isophorone diisocyanate. These polyisocyanate compounds may be used singly, or in combination of two or more kinds thereof.

A thickness of the film is not particularly limited; however, it is usually in a range of 0.1 μm to 1,000 μm. The thickness of the film can be measured using an electromagnetic induction-type film thickness meter when the base metal is a magnetic metal, or an eddy current-type film thickness meter when the base metal is a non-magnetic metal.

### <Method of Producing Electronic Component Having Film On Entirety or Portion of Metal Part>

The electronic component having a film on the entirety or a portion of a metal part according to the present embodiment can be obtained by forming a film on the entirety or a portion of a metal part of an electronic component of interest by an electrodeposition painting method or the like using a surface treatment agent containing a resin or a salt thereof.

The surface treatment agent according to the present embodiment contains the resin or salt thereof in the form of an emulsion.

The emulsion can be obtained by, for example, dispersing the resin or salt thereof in water by a phase-inversion emulsification method. A temperature at which the resin or salt thereof is dispersed is not particularly limited; however, it is preferably 5° C. to 50° C.

The emulsion may further contain a curing agent. The curing agent is not particularly limited as long as it is capable of crosslinking the resin, and examples of the curing agent include blocked polyisocyanate compounds, amine compounds, and melamine. Thereamong, a blocked polyisocyanate compound is preferred. Further, a curing catalyst may be incorporated along with the curing agent. When these components are incorporated, the emulsion can be obtained by mixing the resin or salt thereof with the curing agent and the curing catalyst in advance, and subsequently dispersing the resulting mixture in water by a phase-inversion emulsification method. In the process of obtaining the emulsion, after mixing the resin with the curing agent and the curing catalyst, the above-described neutralization of amino groups may be performed to convert the resin into a salt form.

The blocked polyisocyanate compound is an addition-reaction product of the above-described polyisocyanate compound and a blocking agent, preferably an addition-reaction product of substantially stoichiometric amounts of the polyisocyanate compound and a blocking agent.

The blocking agent blocks other compounds from being added to and reacting with isocyanate groups of the polyisocyanate compound. The blocked polyisocyanate compound generated by blocking isocyanate groups with the blocking agent in this manner is stable at normal temperature. The blocked polyisocyanate compound is desirably one in which the blocking agent blocking isocyanate groups can be dissociated at the time of baking a paint formed by the cationic electrodeposition paint composition of the present invention. The temperature of the baking is usually about 100 to 200° C.

Examples of a blocking agent satisfying these requirements include: lactam compounds, such as ε-caprolactam and γ-butyrolactam; oxime compounds, such as methyl ethyl ketoxime and cyclohexanone oxime; phenolic compounds, such as phenol, para-t-butyl phenol, and cresol; alcohols, such as n-butanol and 2-ethyl hexanol; and ether alcohol compounds, such as ethylene glycol monobutyl ether and ethylene glycol monohexyl ether. These blocking agents may be used singly, or in combination of two or more kinds thereof. In order to efficiently perform the addition and dissociation reactions of the blocking agent and to efficiently obtain an intended addition-reaction product, isocyanate groups in the polyisocyanate compound may be reacted with hydroxy groups of a modified epoxy resin, and some or all of other isocyanate groups in the polyisocyanate compound may be blocked with the blocking agent.

Further, in order to perform the addition and dissociation reactions of the blocking agent more efficiently, a catalyst other than the above-described curing catalyst can be incorporated as appropriate. As this catalyst, any commercially available catalyst can be used as appropriate.

As the curing catalyst, any known catalyst, examples of which include tin-based catalysts, bismuth-based catalysts, titanium-based catalysts, zirconium catalysts, amine-based catalysts, carboxylate-based catalysts, and trialkyl phosphine-based catalysts, can be used. These curing catalysts may be used singly, or in combination of two or more kinds thereof.

The above-described emulsion may further contain a phenol structure-containing resin. The “phenol structure-containing resin” means a resin that contains a phenol group optionally having a single substituent. Examples of the substituent include: alkyl groups, such as a methyl group and an isopropyl group; and a phenol group. The position of the substituent is not particularly limited; however, it is preferably the ortho-position with respect to the OH group of the phenol group.

The phenol structure-containing resin can be produced by reacting a diepoxy compound (b1) and/or an epoxy resin (b2) having an epoxy equivalent of 170 to 500 with a bisphenol compound (b3) at an equivalent ratio [Epoxy groups in diepoxy compound (b1) and epoxy resin (b2)]/[Phenol groups of bisphenol compound (b3)] of 0.5 to 0.85.

The diepoxy compound (b1) is a compound represented by the following Formula (7) and/or a compound represented by the following Formula (8).

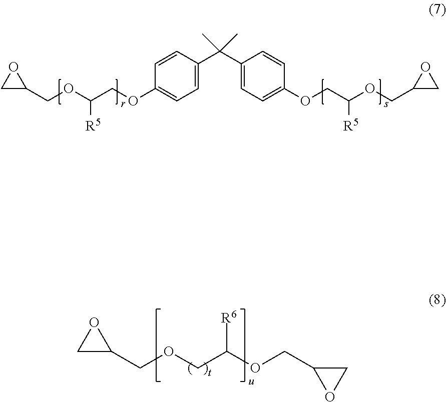

In Formula (7), two R⁵s each independently represent a hydrogen atom or an alkyl group having 1 to 6 carbon atoms; and r and s, which are each the number of repeating units of alkylene oxide structure moiety, represent integers satisfying r+s=1 to 20.

In Formula (8), R⁶ represents a hydrogen atom or an alkyl group having 1 to 6 carbon atoms; t represents an integer of 1 to 9; and u represents an integer of 1 to 50.

The epoxy resin (b2) is a compound other than the diepoxide compound (b1), which contains two or more epoxy groups in one molecule and has a number-average molecular weight in a range of 340 to 1,500, preferably 340 to 1,000, and an epoxy equivalent in a range of 170 to 500, preferably 170 to 400. The epoxy resin (b2) can be obtained by, for example, a reaction between a polyphenol compound and an epihalohydrin.

The “number-average molecular weight” was calculated based on the elution time corresponding to the molecular weight of standard polystyrene in an analysis of the epoxy resin (b2) that was performed using a gel permeation chromatograph in accordance with the method prescribed in JIS K0124-83. As the gel permeation chromatograph, “HLC8320GPC” (manufactured by Tosoh Corporation) was used. As columns, “TSKgel SuperAWM-H” and “TSKgel guardcolum α” (both of which are manufactured by Tosoh Corporation, trade names) were used. The analysis was performed using a differential refractive index (RI) detector under the following conditions: mobile phase=N,N-dimethylformamide, measurement temperature=40° C., and flow rate=0.5 ml/min.

Examples of the polyphenol compound used for the production of the epoxy resin (b2) include bis(4-hydroxyphenyl)-2,2-propane [bisphenol A], bis(4-hydroxyphenyl)methane [bisphenol F], bis(4-hydroxycyclohexyl)methane [hydrogenated bisphenol F], 2,2-bis(4-hydroxycyclohexyl)propane [hydrogenated bisphenol A], 4,4′-dihydroxybenzophenone, bis(4-hydroxyphenyl)-1,1-ethane, bis(4-hydroxyphenyl)-1,1-isobutane, bis(4-hydroxy-2 or 3-tert-butyl-phenyl)-2,2-propane, bis(2-hydroxynaphthyl)methane, tetra(4-hydroxyphenyl)-1,1,2,2-ethane, 4,4′-dihydroxydiphenylsulfone, phenol novolac, and cresol novolac.

Among epoxy resins obtained by a reaction between a polyphenol compound and epichlorohydrin, an epoxy resin represented by the following Formula (9), which is derived from bisphenol A, is preferred.

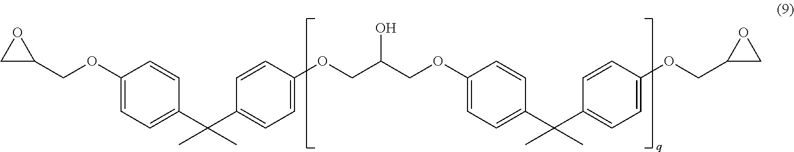

[wherein, q represents an integer of 0 to 2]

The bisphenol compound (b3) is a compound represented by the following Formula (10). In Formula (10), R⁷, R¹, R⁹, R¹⁰, R¹¹, R¹², R¹³, R¹⁴, R¹⁵, and R¹⁶ each independently represent a hydrogen atom or an alkyl group having 1 to 6 carbon atoms. Examples of the bisphenol compound (b3) include bis(4-hydroxyphenyl)-2,2-propane [bisphenol A] and bis(4-hydroxyphenyl)methane [bisphenol F].

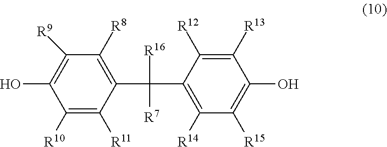

The production of the phenol structure-containing resin can be usually performed by mixing the diepoxy compound (b1) and/or the epoxy resin (b2) having an epoxy equivalent of 170 to 500 with the bisphenol compound (b3), and allowing the resultant to react in a temperature range of 80 to 200° C., preferably 90 to 180° C., for a period of 1 to 10 hours, preferably 1 to 8 hours, using, as appropriate, a tertiary amine such as N,N-dimethylbenzylamine or tributylamine, a quaternary ammonium salt such as tetraethylammonium bromide or tetrabutylammonium bromide, or the like as a reaction catalyst.

The phenol structure-containing resin obtained in this manner preferably has a hydroxyl value in the phenol structure of 20 to 112 mgKOH/g, preferably 25 to 110 mgKOH/g, and a number-average molecular weight of 800 to 15,000, preferably 900 to 10,000.

The above-described emulsion can be produced by, for example, adding the above-described neutralizing acid to a mixture of the resin and the curing agent (this mixture may further contain the phenol structure-containing resin), mixing the resultant with stirring, and then diluting the resultant with water. Amino groups are cationized for the purpose of providing water dispersibility. The cationization may be performed for all of the amino groups, or may be performed for some of the amino groups.

The amount of an acid used for the cationization is not particularly limited. However, when the amount is small, the emulsion may not be satisfactory due to a small amount of cations providing water dispersibility, whereas when the amount is large, an increase in the electrical conductivity of the emulsion may lead to deterioration of the outer appearance of a paint formed by a surface treatment agent containing the emulsion; therefore, the amount of the acid is preferably adjusted as appropriate such that the surface treatment agent has an electrical conductivity of less than 1,000 μS/cm.

The surface treatment agent can be produced by mixing the above-described resin emulsion with stirring along with, as required, the above-described liquid medium, pigment paste, organic solvent, surfactant, antifoaming agent, and the like. It is noted here that the surface treatment agent may be an undiluted surface treatment agent having a high concentration, or may be a low-concentration surface treatment agent that is obtained by adjusting a high-concentration surface treatment agent to have a desired concentration through dilution with deionized water or the like as appropriate.

The pH of the surface treatment agent is not particularly limited; however, it is preferably in a range of 2.0 to 8.0, more preferably in a range of 3.0 to 6.0. A substance that can be used for adjusting the pH is not particularly limited, and any known acid or base can be used. For example, an acid such as formic acid, acetic acid, lactic acid, nitric acid, sulfamic acid, methanesulfonic acid, or benzenesulfonic acid, or a base such as an aqueous ammonia, monoethanolamine, diethanolamine, or triethanolamine can be used as appropriate. In the present specification, the pH value is a value measured at 25° C. using a commercially available pH meter.

The surface treatment agent preferably has an electrical conductivity of less than 1,000 μS/cm at 25° C. The electrical conductivity can be measured using a commercially available electrical conductivity meter (e.g., a multi-function water quality meter MM-60R, manufactured by DKK-TOA Corporation).

The electronic component according to the present embodiment which includes a film on the entirety or a portion of a metal part can be obtained by, for example, electrodeposition painting in which a material to be painted, which serves as a cathode, is immersed in the above-described surface treatment agent, and electrification is subsequently performed. The voltage applied in the electrification is usually in a range of 50 V to 400 V, preferably 100 V to 300 V, but not limited thereto. During the electrodeposition painting, the temperature of the surface treatment agent is usually in a range of 10 to 50° C., preferably 15 to 40° C., but not limited thereto. After the electrodeposition painting, the drying step is performed so as to cure the thus formed film. The drying of the film is performed in a condition where, for example, the surface temperature of the painted material is in a range of preferably about 100° C. to about 200° C., more preferably about 140° C. to about 180° C. By drying and curing the film in this manner, the electronic component according to the present embodiment which includes a film on the entirety or a portion of a metal part can be obtained. It is noted here that, if necessary, the water-washing step may be incorporated between the electrodeposition painting step and the drying step. The water-washing step can be performed using, for example, an ultrafiltrate, a reverse osmosis permeate, an industrial water, or pure water.

Further, the degreasing treatment step may also be performed before the electrodeposition painting step. This degreasing treatment may be performed by any known method using a degreasing treatment agent appropriate for the electronic component. Examples of the degreasing treatment agent include, but are not limited to, known acidic degreasing agents, alkaline degreasing agents, and solvent degreasing agents. Examples of a degreasing method include, but are not particularly limited to, scrub cleaning, spray cleaning (jet cleaning), and dip (immersion) cleaning. The water-washing step of washing the surface of the electronic component may be performed after the degreasing treatment step but before the electrodeposition painting step, and the drying step of drying the surface of the electronic component may be further performed after the water-washing step but before the electrodeposition painting step. As a drying method, any known method can be applied.

Moreover, the chemical conversion treatment step of forming a chemical conversion film on the metal part of the electronic component may be performed before the electrodeposition painting step, but after the degreasing treatment step, the water-washing step, the drying step, and the like that are performed before the electrodeposition painting step. This chemical conversion treatment is performed by bringing the electronic component into contact with a known chemical conversion treatment agent. A chemical conversion treatment method is not particularly limited, and any known method can be applied. The water-washing step may be performed after the chemical conversion treatment step but before the electrodeposition painting step, and the drying step may be performed after the water-washing step but before the electrodeposition painting step.

### EXAMPLES

The present invention will now be described in more detail by way of Production Examples, Examples, and Comparative Examples; however, the present invention is not limited thereto. The materials to be treated, degreasing agents, and paints that were used in Examples were arbitrarily selected from commercially available materials, and should not limit the actual use of the surface treatment composition, surface treatment liquid, and surface treatment method of the present invention. Further, unless otherwise specified, “%” and “part(s)” hereinafter mean “% by mass” and “part(s) by mass”, respectively. Some of the raw materials used for the synthesis of epoxy resin (A1) are shown in Table 1 below.

TABLE 1

| | |
|---|---|
| a1-1 | 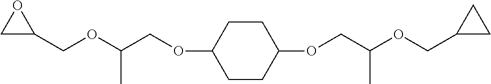 [SMILES: CC(COC1CCC(OCC(C)OCC2CO2)CC1)OCC1CC1] |
| a1-2 | 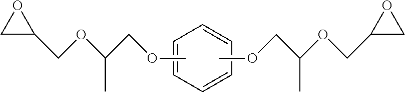 |
| a1-3 | 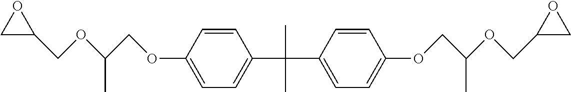 [SMILES: CC(COc1ccc(C(C)(C)c2ccc(OCC(C)OCC3CO3)cc2)cc1)OCC1CO1] |
| a2-1 | 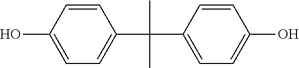 [SMILES: CC(C)(c1ccc(O)cc1)c1ccc(O)cc1] |
| a3-1 | 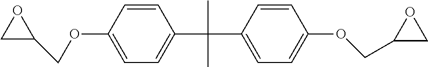 [SMILES: CC(C)(c1ccc(OCC2CO2)cc1)c1ccc(OCC2CO2)cc1] |
| a4-1 | 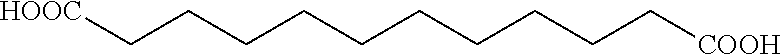 [SMILES: O=C(O)CCCCCCCCCCC(=O)O] |
| a4-2 | HARIDIMER270S |
| a4-3 | 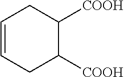 [SMILES: O=C(O)C1CC=CCC1C(=O)O] |

### Production Example 1

In a 2-L separable flask equipped with a thermometer, a reflux condenser, and a stirrer, 110.9 g of the propylene oxide-added diepoxy resin (a1-1), 183.1 g of the bisphenol compound (a2-1), 331.1 g of the diepoxy resin (a3-1), 46.2 g of the dicarboxylic acid (a4-1), and 0.75 g of dimethylbenzylamine were added and allowed to react at 130° C. until an epoxy equivalent of 2,000 was obtained, after which the reaction was quenched with an addition of 440.1 g of butyl cellosolve to obtain an epoxy resin (A1). In another 2-L separable flask equipped with a thermometer, a reflux condenser, and a stirrer, 1,000.0 g of the thus obtained epoxy resin (A1) was weighed, and 27.1 g of diethanolamine (A2-1) was added thereto and allowed to react at 90° C. for 4 hours to obtain an amino group-modified epoxy resin having a solid content of 70%. This resin had an amine value of 15.0 mgKOH/g. In an appropriate container, 650.0 g of the thus obtained amino group-modified epoxy resin was weighed and blended with 10.0 g of methanesulfonic acid, and the resultant was uniformly stirred, after which 740.0 g of deionized water was added thereto over a period of about 10 minutes with vigorous stirring, whereby an emulsion having a solid content of 33% was obtained.

### Production Examples 2 to 6 and 8

Emulsions of Production Examples 2 to 6 and 8 were each produced in the same manner as in Production Example 1, except that the composition was changed as shown in Table 2.

### <Production of Blocked Polyisocyanate-Type Curing Agent (B)>

In a reaction vessel, 115.6 g of methyl isobutyl ketone was added to 678.4 g of COSMONATE M-200 (trade name, manufactured by Mitsui Chemicals, Inc.; crude MDI), and the resultant was heated to 70° C., after which 706.0 g of butyl cellosolve was slowly added dropwise, followed by heating to 90° C. These materials were allowed to react for 12 hours at 90° C. to obtain a blocked polyisocyanate-type curing agent. When the infrared absorption spectrum was measured, absorption attributed to an unreacted isocyanate group was not observed, and it was thus confirmed that isocyanate groups were completely blocked.

### Production Example 7

An amino group-modified epoxy resin was obtained in the same manner as in Production Example 1, except that the composition was changed as shown in Table 2. The thus obtained amino group-modified epoxy resin in an amount of 650.0 g was mixed with 165.3 g of a blocked polyisocyanate compound, and the resultant was further blended with 10.0 g of methanesulfonic acid and uniformly stirred, after which 1,094.0 g of deionized water was added thereto over a period of about 10 minutes with vigorous stirring, whereby an emulsion having a solid content of 33% was obtained.

TABLE 2

| | | | | | | | | | | | Blocked |
|---|---|---|---|---|---|---|---|---|---|---|---|
| | Epoxy resin | | | | | | | | | | polyisocyanate-type |
| | a1 | | a2 | | a3 | | a4 | | Amine compound | | curing agent (B) |
| | | Added | | Added | | Added | | Added | | Added | Added |
| | Type | amount | Type | amount | Type | amount | Type | amount | Type | amount | amount |
| Production | a1-1 | 110.9 | a2-1 | 183.1 | a3-1 | 331.1 | a4-1 | 46.2 | diethanolamine | 27.1 | — |
| Example1 | | | | | | | | | | | |
| Production | a1-2 | 109.3 | a2-1 | 183.6 | a3-1 | 332.0 | a4-1 | 46.3 | diethanolamine | 27.2 | — |
| Example2 | | | | | | | | | | | |
| Production | a1-3 | 186.8 | a2-1 | 159.5 | a3-1 | 288.4 | a4-1 | 40.2 | diethanolamine | 23.6 | — |
| Example3 | | | | | | | | | | | |
| Production | a1-3 | 171.8 | a2-1 | 146.7 | a3-1 | 265.2 | a4-2 | 93.3 | diethanolamine | 21.7 | — |
| Example4 | | | | | | | | | | | |
| Production | a1-3 | 189.7 | a2-1 | 161.9 | a3-1 | 292.8 | a4-3 | 30.2 | diethanolamine | 24.0 | — |
| Example5 | | | | | | | | | | | |
| Production | a1-1 | 112.1 | a2-1 | 185.2 | a3-1 | 334.8 | a4-1 | 46.7 | methylethanolamine | 19.6 | — |
| Example6 | | | | | | | | | | | |
| Production | a1-1 | 95.3 | a2-1 | 157.4 | a3-1 | 284.6 | a4-1 | 39.7 | methylethanolamine | 16.6 | 165.3 |
| Example7 | | | | | | | | | | | |
| Production | — | — | a2-1 | 180.2 | a3-1 | 446.2 | a4-1 | 45.4 | diethanolamine | 26.7 | — |
| Example8 | | | | | | | | | | | |

### <Production of Surface Treatment Agent>

A surface treatment agent was produced by diluting the emulsion of Production Example 1 with deionized water such that the solid content was 16.0%.

Surface treatment agents were produced in the same manner using the emulsions of Production Examples 2 to 8.

Further, a surface treatment agent was produced by diluting an acryl-ester copolymer (NIPOL SX1706A, manufactured by Zeon Corporation) with deionized water such that the solid content was 16.0%.

### <Production of Test Plate>

A metal plate (a cold-rolled steel plate (SPCC-SD), an aluminum alloy plate (A5052), or an oxygen-free copper alloy plate (C1020P) was degreased (spray treatment with FINE CLEANER E2001 (manufactured by Nihon Parkerizing Co., Ltd., trade name) at 43° C. for 2 minutes), and then washed with water to be cleaned. Subsequently, using the thus cleaned metal plate as a material to be painted, each surface treatment agent was electrodeposition-painted thereon at 200 V for 3 minutes, followed by washing with water. Thereafter, the surface treatment agent was dried at 180° C. (painted material surface temperature) and thereby cured to obtain a test plate having a 20 μm-thick film. The emulsions in the respective surface treatment agents and the metal materials that were used in Examples and Comparative Examples are as shown in Table 3.

### <Evaluation Tests>

Various evaluation tests were conducted using the above-produced test plates. The results thereof are shown in Table 3.

### <Insulation Test>

The dielectric breakdown voltage of the film of each test plate was measured using a withstand voltage tester (TOS9201, manufactured by Kikusui Electronics Corporation). The measurement was performed at an initial voltage of 50 V, a voltage increase rate of 50 V/see, and a cut-off current of 1.0 mA. The insulation of the film was evaluated based on the dielectric breakdown voltage per unit film thickness, which was calculated by dividing the measured dielectric breakdown voltage by the thickness of the film.

### <High-Temperature High-Humidity Test>

Each test plate was left to stand for 3,000 hours in a thermo-hygrostat chamber (ETAC HIFLEX, manufactured by Kusumoto Chemicals, Ltd.) set at a temperature of 85° C. and a relative humidity of 85%. The dielectric breakdown voltage per unit film thickness of the test plate was measured at each time point of before leaving the test plate in the thermo-hygrostat chamber (initial) and after the 3,000 hours, and a ratio of the dielectric breakdown voltage after the 3,000 hours with respect to the initial dielectric breakdown voltage of the film (insulation retention rate after high-temperature high-humidity test) was calculated. Based on the thus obtained ratio, the high-temperature high-humidity test was evaluated by the following criteria, and an evaluation of A or B was regarded as satisfactory.
A: The insulation retention rate after the high-temperature high-humidity test was 0.9 or higher.
B: The insulation retention rate after the high-temperature high-humidity test was 0.6 or higher but lower than 0.9.
C: The insulation retention rate after the high-temperature high-humidity test was lower than 0.6.

### <Thermal Cycle Test>

Each test plate was left to stand in a temperature cycle tester (ETAC WINTEC, manufactured by Kusumoto Chemicals, Ltd.), and the temperature inside the tester was changed in the following order of 1. to 4. (the temperature changes of 1. to 4. were defined as one cycle).
1. Maintain the test plate at −50° C. for 30 minutes.
2. Heat the test plate to 150° C.
3. Maintain the test plate at 150° C. for 30 minutes.
4. Cool the test plate to −50° C.

The dielectric breakdown voltage per unit film thickness of the test plate was measured at each time point of before leaving the test plate in the temperature cycle tester (initial) and after 1,000 cycles, and a ratio of the dielectric breakdown voltage after 1,000 cycles with respect to the initial dielectric breakdown voltage of the film (insulation retention rate after thermal cycle test) was calculated. Based on the thus obtained ratio, the thermal cycle test was evaluated by the following criteria, and an evaluation of A or B was regarded as satisfactory.
A: The insulation retention rate after the thermal cycle test was 0.9 or higher.
B: The insulation retention rate after the thermal cycle test was 0.6 or higher but lower than 0.9.
C: The insulation retention rate after the thermal cycle test was lower than 0.6.

### <High-Temperature Exposure Test>

Each test plate was left to stand for 3,000 hours in an oven set at 150° C. The dielectric breakdown voltage per unit film thickness of the test plate was measured at each time point of before leaving the test plate in the oven (initial) and after the 3,000 hours, and a ratio of the dielectric breakdown voltage after the 3,000 hours with respect to the initial dielectric breakdown voltage of the film (insulation retention rate after high-temperature exposure test) was calculated. Based on the thus obtained ratio, the high-temperature exposure test was evaluated by the following criteria, and an evaluation of A or B was regarded as satisfactory.
A: The insulation retention rate after the high-temperature exposure test was 0.9 or higher.
B: The insulation retention rate after the high-temperature exposure test was 0.6 or higher but lower than 0.9.
C: The insulation retention rate after the high-temperature exposure test was lower than 0.6.

TABLE 3

| | | | High-temperature high-humidity test | | | | Thermal cycle test | | | | High-temperature exposure test | | | |
|---|---|---|---|---|---|---|---|---|---|---|---|---|---|---|
| | | | Dielectric | | | | Dielectric | | | | Dielectric | | | |
| | Emulsion | | breakdown | | | | breakdown | | | | breakdown | | | |
| | in | | voltage | | | | voltage | | | | voltage | | | |
| | surface | | [V/μm] | | Insulation | | [V/μm] | | Insulation | | [V/μm] | | Insulation | |
| | treatment | Test | Before | After | retention | Eval- | Before | After | retention | Eval- | Before | After | retention | Eval- |
| | agent | plate | test | test | rate | uation | test | test | rate | uation | test | test | rate | uation |
| Example 1 | Production | SPCC-SD | 110 | 102 | 0.93 | A | 104 | 88 | 0.85 | B | 111 | 105 | 0.95 | A |
| | Example 1 | | | | | | | | | | | | | |
| Example 2 | Production | SPCC-SD | 108 | 103 | 0.95 | A | 101 | 85 | 0.84 | B | 108 | 103 | 0.95 | A |
| | Example 2 | | | | | | | | | | | | | |
| Example 3 | Production | SPCC-SD | 100 | 97 | 0.97 | A | 103 | 99 | 0.96 | A | 110 | 106 | 0.96 | A |
| | Example 3 | | | | | | | | | | | | | |
| Example 4 | Production | SPCC-SD | 104 | 101 | 0.97 | A | 110 | 105 | 0.95 | A | 103 | 100 | 0.97 | A |
| | Example 4 | | | | | | | | | | | | | |
| Example 5 | Production | SPCC-SD | 101 | 96 | 0.95 | A | 106 | 101 | 0.95 | A | 102 | 97 | 0.95 | A |
| | Example 5 | | | | | | | | | | | | | |
| Example 6 | Production | SPCC-SD | 102 | 98 | 0.96 | A | 101 | 96 | 0.95 | A | 101 | 96 | 0.95 | A |
| | Example 6 | | | | | | | | | | | | | |
| Example 7 | Production | SPCC-SD | 103 | 98 | 0.95 | A | 105 | 102 | 0.97 | A | 107 | 103 | 0.96 | A |
| | Example 7 | | | | | | | | | | | | | |
| Example 8 | Production | C1020P | 105 | 101 | 0.96 | A | 107 | 102 | 0.95 | A | 105 | 101 | 0.96 | A |
| | Example 1 | | | | | | | | | | | | | |
| Example 9 | Production | A5052 | 106 | 102 | 0.96 | A | 103 | 99 | 0.96 | A | 103 | 97 | 0.94 | A |
| | Example 1 | | | | | | | | | | | | | |
| Comparative | Production | SPCC-SD | 103 | 36 | 0.35 | C | 103 | 23 | 0.22 | C | 105 | 32 | 0.30 | C |
| Example 1 | Example 8 | | | | | | | | | | | | | |
| Comparative | Acryl-ester | SPCC-SD | 104 | 32 | 0.31 | C | 101 | 20 | 0.20 | C | 107 | 27 | 0.25 | C |
| Example 2 | copolymer | | | | | | | | | | | | | |

The present invention has been described above in detail referring to concrete Examples thereof, however, it is obvious to those skilled in the art that various modifications and changes can be made without departing from the spirit and the scope of the present invention.

1. An electronic component, comprising:
a metal part; and
a film on the entirety or a portion of the metal part,
wherein
the film comprises an amino group-modified epoxy resin or a salt thereof which is obtained by reacting an epoxy resin (A1) and an amine compound (A2), and
the epoxy resin (A1) is obtained by reacting a propylene oxide-added diepoxy resin (a1) represented by Formula (1), a bisphenol compound (a2), a diepoxy resin (a3) different from Formula (1), and a dicarboxylic acid (a4) in which two carboxyl groups are bound via at least one carbon atom: 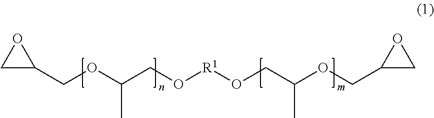
wherein, R¹ represents an alkylene group having 3 to 10 carbon atoms which optionally has a substituent, a cyclohexylene group which optionally has a substituent, a phenylene group which optionally has a substituent, or -Ra-Rb-Rc-; Ra and Rc each represent a cyclohexylene group or a phenylene group; Rb represents a methylene group which optionally has one or two substituents; and m and n each independently represent an integer of 1 to 20.

2. The electronic component according to claim 1, which is selected from the group consisting of an electronic component, a bus bar, a reactor, an electric wire, and a sintered magnet, which constitute a motor.

3. An electronic component, comprising:
a metal part; and
a film on the entirety or a portion of the metal part,
wherein
the film comprises an amino group-modified epoxy resin or a salt thereof, and the resin comprises a structural unit derived from an epoxy resin (A1) and a structural unit derived from an amine compound (A2), and
the epoxy resin (A1) comprises a structural unit derived from a propylene oxide-added diepoxy resin (a1) represented by Formula (1), a structural unit derived from a bisphenol compound (a2), a structural unit derived from a diepoxy resin (a3) different from Formula (1), and a structural unit derived from a dicarboxylic acid (a4) in which two carboxyl groups are bound via at least one carbon atom: 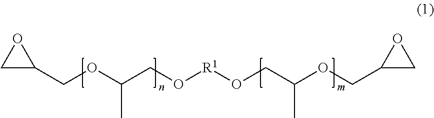
wherein, R¹ represents an alkylene group having 3 to 10 carbon atoms which optionally has a substituent, a cyclohexylene group which optionally has a substituent, a phenylene group which optionally has a substituent, or -Ra-Rb-Rc-; Ra and Rc each represent a cyclohexylene group or a phenylene group; Rb represents a methylene group which optionally has one or two substituents; and m and n each independently represent an integer of 1 to 20.
